(19) United States
(12) Patent Application Publication
(10) Pub. No.: US 2026/0211118 A1
(43) Pub. Date: Jul. 23, 2026

(54) RECONFIGURABLE INTELLIGENT SURFACE WITH INTEGRATED LIGHT DETECTION AND RANGING (LiDAR) FOR SENSING AND COMMUNICATION

(71) Applicant: Dell Products L.P., Round Rock, TX (US)

(72) Inventors: Tejinder Singh, Manotick (CA); Navjot Kaur Khaira, Manotick (CA); Seán Ahearne, Cork (IE)

(21) Appl. No.: 19/030,366

(22) Filed: Jan. 17, 2025

(51) Int. Cl. G01S 17/894; G01S 7/4865; G06V 10/764; G06V 10/82

(52) U.S. Cl. CPC G01S 17/894; G01S 7/4865; G06V 10/764; G06V 10/82

(57) ABSTRACT

The technology described herein is directed towards integration of a light detection and ranging (LiDAR) system with a reconfigurable intelligent surface (RIS) for reconfiguration of the RIS based on a currently sensed 3D environment. Combining RIS and LiDAR facilitates accurate environmental mapping, resulting in improved signal quality, adaptive beamforming, better localization and tracking, resource efficiency, enhanced security, and support for advanced applications. Artificial intelligence/machine learning (AI/ML) models can process the high-resolution three-dimensional (3D) data captured via LiDAR to identify and classify objects in the environment. In one implementation, a PointNet++ model identifies and classifies objects in a sensed environment, which is used by a deep reinforcement learning model to determine a RIS configuration for the environment. Precise localization data facilitates a RIS's ability to dynamically adjust signal reflections to avoid obstacles, reduce interference, and perform more effective beamforming, leading to more optimal signal direction and coverage.

### BACKGROUND

A reconfigurable intelligent surface includes an array of passive reflecting elements, each of which can independently impose a phase shift on the incoming signal. By adjusting the phase shifts of the reflecting elements, reflected signals reconfigurable intelligent surface can be reconfigured to propagate towards their desired directions.

### BRIEF DESCRIPTION OF THE DRAWINGS

The technology described herein is illustrated by way of example and not limited in the accompanying figures in which like reference numerals indicate similar elements and in which:

FIG. 1A is a representation of an example reconfigurable intelligent surface (RIS) with an integrated LiDAR (light detection and ranging) system couple to an artificial intelligence (AI) module for reconfiguring the RIS based on real time three-dimensional (3D) mapping data, in accordance with various embodiments and implementations of the subject disclosure.

FIG. 1B is a block diagram showing LiDAR being used to determine the distance and form a surrounding 3D map of an environment for processing by an AI module to obtain RIS reconfiguration data, in accordance with various embodiments and implementations of the subject disclosure.

FIG. 2 is a representation of LiDAR-captured data of an environment (e.g., a meeting room) that includes an object classified as a human, in accordance with various embodiments and implementations of the subject disclosure.

FIG. 3 is a representation of LiDAR-captured data of an environment in which the human of FIG. 2 is no longer present in the environment, in accordance with various embodiments and implementations of the subject disclosure.

FIGS. 4-6 comprise a sequence diagram of example operations for an AI-enabled LiDAR integrated with RIS and coupled to an AI model that outputs RIS reconfiguration data based on LiDAR sensed data, in accordance with various embodiments and implementations of the subject disclosure.

FIGS. 7 and 8 comprise an operation and dataflow diagram representing various operations performed by a neural network (e.g., PointNet++) and deep reinforcement learning models for reconfiguring a RIS, in accordance with various embodiments and implementations of the subject disclosure.

FIG. 9 is a flow diagram showing example operations related to inputting object identification data classified from LiDAR data to a trained model set to determine reconfigurable intelligent surface configuration data, in accordance with various embodiments and implementations of the subject disclosure.

FIG. 10 is a flow diagram showing example operations related to classifying LiDAR data for determining configuration data for a reconfigurable intelligent surface, in accordance with various embodiments and implementations of the subject disclosure.

### DETAILED DESCRIPTION

The technology described herein is generally directed towards a reconfigurable intelligent surface (RIS) coupled to a light detection and ranging (LiDAR) system. As will be understood, a RIS and LiDAR system combination allows for more accurate environmental mapping, improved signal quality, adaptive beamforming, better localization and tracking, resource efficiency, enhanced security, and support for advanced applications.

In one example implementation, the LiDAR system is integrated with a RIS hardware module, in which artificial intelligence/machine learning (AI/ML) models can process the high-resolution three-dimensional (3D) data captured via LiDAR to identify and classify objects in the environment. Via LiDAR-sensed data, more precise localization data is available, which facilitates a RIS's ability to dynamically adjust signal reflections to avoid obstacles, reduce interference, and perform more effective beamforming, leading to more optimal signal direction and coverage.

In systems without such real-time environmental awareness, the generally static nature of RIS configurations can be a problem in dynamic environments, where objects and users are regularly moving. Moreover, security and privacy concerns can arise, as without such real-time environmental data, a RIS cannot help to detect unauthorized intrusions or autonomously ensure secure communication paths.

It should be understood that any of the examples herein are non-limiting. As one example, one or more artificial intelligent models are described; however these are nonlimiting examples, and other models, including those not yet developed, can be leveraged by the technology described herein. Thus, any of the embodiments, aspects, concepts, structures, functionalities or examples described herein are non-limiting, and the technology may be used in various ways that provide benefits and advantages in communications and reconfigurable intelligent surfaces in general. It also should be noted that terms used herein, such as “optimize” or “optimal” and the like only represent objectives to move towards a more optimal state, rather than necessarily obtaining ideal results.

Reference throughout this specification to “one embodiment,” “an embodiment,” “one implementation,” “an implementation,” etc. means that a particular feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. Repetitive description of like elements employed in respective embodiments may be omitted for sake of brevity.

The following detailed description is merely illustrative and is not intended to limit embodiments and/or application or uses of embodiments. Furthermore, there is no intention to be bound by any expressed or implied information presented in the preceding sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Further, it is to be understood that the present disclosure will be described in terms of a given illustrative architecture; however, other architectures, structures, substrate materials and process features, and steps can be varied within the scope of the present disclosure.

Example implementations and embodiments of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

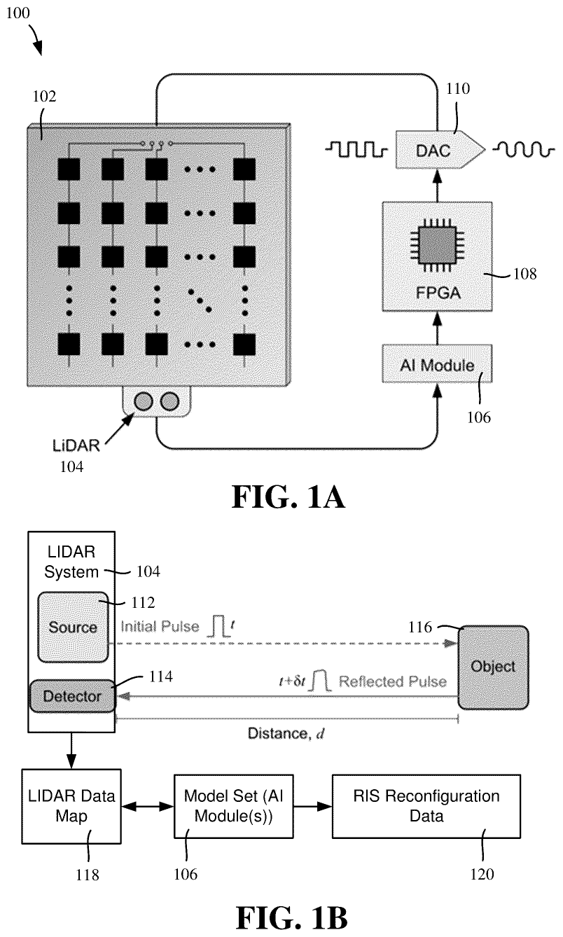

FIG. 1A shows an example implementation/system 100 of AI-enabled LiDAR and RIS integration, in which a RIS (panel) 102 is coupled to a LiDAR system 104 that senses a 3D environment, e.g., resulting in a LiDAR data map in the form of a point cloud of data points including distance data for each data point; (3D point clouds are a collection of data points that represent the three-dimensional shape and surface characteristics of objects in the environment). The LiDAR system 104 includes or is coupled to a trained model set (AI module 106) including one AI classification module that can classify the objects in the 3D data map, and one AI processing module that can determine how to reconfigure the RIS 102 based on the objects detected (classified) and their locations. For example, the RIS can be reconfigured to beamform a reflected signal towards a communications device (e.g., a laptop computer) detected in a meeting room, or beamform a wider reflected signal towards a number of communication devices in the same room.

As depicted in FIG. 1B, a primary function of the LiDAR system 104 involves sending out laser light from a source (transmitter) 112 and receiving at a receiver 114 the reflected signal bouncing back from an object 114 in a surrounding environment. A LiDAR system maps a region (the surrounding environment) by rapidly emitting laser pulses, on the order of hundreds of thousands or more laser pulses per second, in various directions, measuring the time it takes for each pulse to reflect off the objects in the region. The time lapse between the outgoing light pulse and the reflected light pulse is used to develop a distance map of the objects in the scene; note that LiDAR can also determine the velocity of a moving target using the Doppler technique or measuring the distance to the target in rapid succession.

In the example of FIG. 1B, the LiDAR data map 118 generated in this way is processed by the model set/AI module(s) 106 to obtain RIS reconfiguration data 120. In FIG. 1A, a controller (shown in the example of a field-programmable gate array, or FPGA) 108 along with a DAC (digital-to-analog converter) 110 outputs the signals appropriate for reconfiguring the RIS 102, e.g., voltage biases to each unit cell (element) of the RIS 102.

More particularly, after collecting the data map 118 from LiDAR, an ultralow-power AI chip integrated (or otherwise coupled to) the RIS module executes highly efficient machine learning models to provide the intelligence. The intelligent models in the trained model set 106 learn the environment over time by analyzing the received data about the channel from the LiDAR system 104. The two-dimensional array of unit cells in the RIS 102 can be managed by a programmable logic chip, such as the field-programmable gate array (FPGA) 108, which allows for the storage of numerous coding sequences for dynamically tuning the RIS in response to changes in the sensed environment. The controller issues precise instructions to the individual unit cells, adjusting their states as needed. In the example shown, the digital sequence from the FPGA 108 is converted by the DAC 110 to analog voltage levels for the reconfiguring of the unit cells. The AI module 106 and the FPGA 108 work together to determine an optimal configuration for the RIS cells, adapting to the dynamic environment. This configuration dictates the amplitude and phase shift of the reflected wireless signals from the RIS. The control of a group of unit cells can be synchronized to create constructive (or destructive) interference.

For example, the unit cells each have a voltage-determined phase shift, whereby individual voltages can change the phase response of each unit cell such that an incoming signal is redirected by each unit cell to constructively interfere with the redirected instances of other unit cells to form a beam that is steered in a desired direction; the width of the beam can also be configured. In addition to array gain, some RISs can include additional amplification, whereby it is also feasible to further control the signal strength of the reflected beam.

Combining LiDAR with RIS overcomes a number of problems in the realm of joint sensing and communication. LiDAR provides high-resolution 3D mapping and precise distance measurements of the environment. When integrated with RIS, LiDAR allows for a more accurate and comprehensive understanding of the surroundings, helping to dynamically control the propagation of electromagnetic waves. LiDAR can detect obstacles and provide their exact locations to the RIS. This enables the RIS to dynamically reconfigure the signal paths, avoiding blockages and minimizing interference, thereby maintaining robust communication links. This improved environmental awareness is also useful in applications like autonomous vehicles and smart cities.

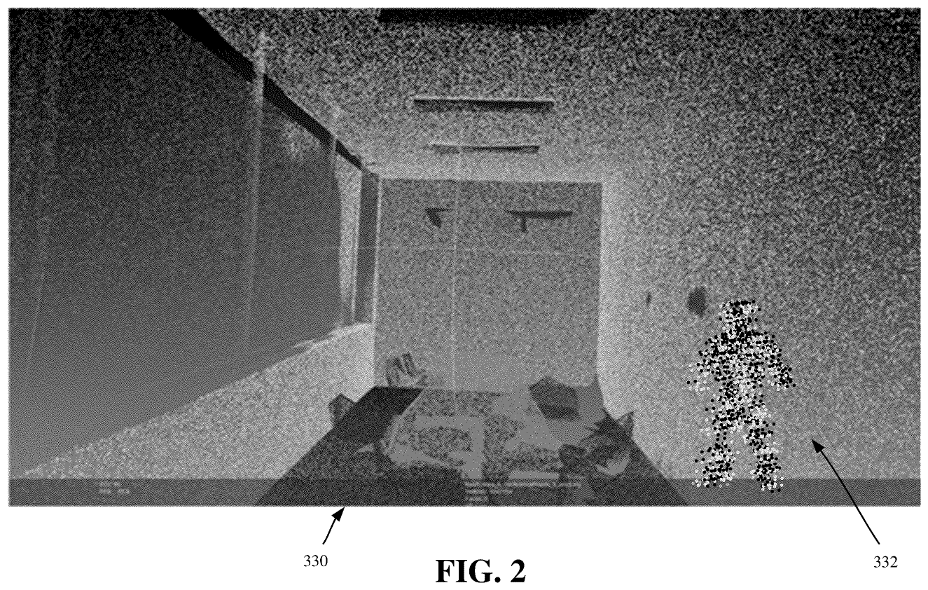

By way of example, consider that a LiDAR system, coupled to a RIS, has captured data corresponding to the environmental mapping 330 shown in FIG. 2, e.g., shown as a representation of a meeting room. A human 332 is classified (as described herein) as being in the room. Based on this, the RIS in the meeting room can be reconfigured (and fully activated if operating in a low power state), to steer reflected communication signals towards that person, and adapt as the person moves around, e.g., pacing with a cell phone while making a wireless phone call. A communications device detected as being in the room can be similarly targeted, and tracked if moving around.

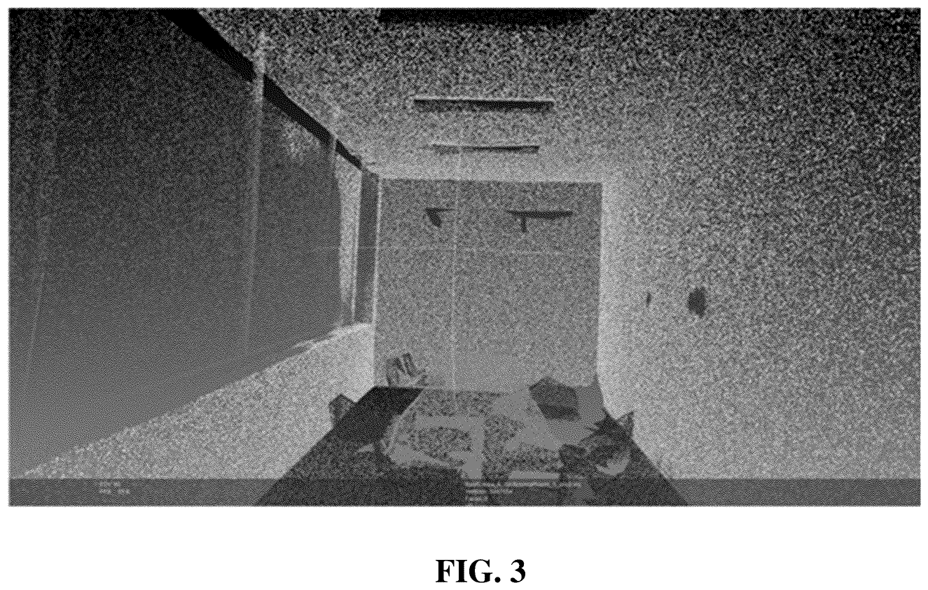

In FIG. 3, the person has left the room, whereby the RIS can be reconfigured, such as to reflect signals to another RIS outside the room; alternatively, a reduced power state can be entered by the system because no human or communication device is present. For example, any RIS amplification or voltage applied to unit cells can be turned off, and/or the rate of LiDAR sensing and processing can be reduced; e.g., one sampling scan repeated every ten seconds to sample whether the environment has changed (e.g., someone has entered the room corresponding to exiting the reduced power state), instead of sensing and processing maps at a more frequent rate more appropriate for a dynamic environment.

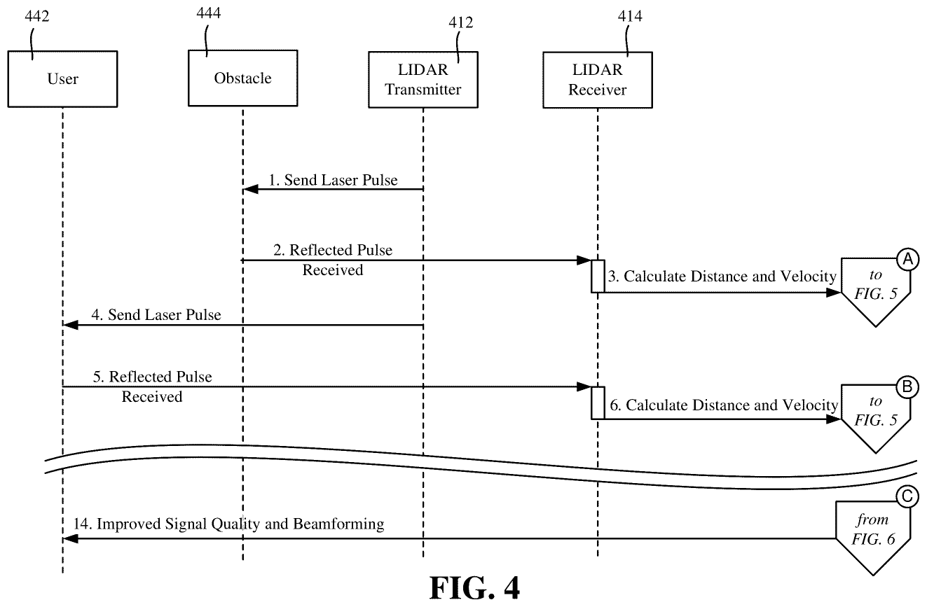

FIGS. 4-6 are a sequence diagram showing example operations and data flow of an AI-enabled LiDAR system integrated with RIS. The process begins at labeled arrow (1), with the LiDAR transmitter 412 sending a laser pulse; (note that similar components to those labeled 1xx in FIGS. 1A and 1B generally correspond to those labeled 4xx in FIGS. 4-6). When the transmitted pulse hits an obstacle 444, the reflected pulse is received at arrow (2), with the distance (and any obstacle velocity) calculated (arrow (3)) via timing. Similarly, arrows (4) - (6) represent a user 442 reflecting a pulse; as is understood, many such pulses in various directions are transmitted and received, resulting in a 3D point cloud (possibly accompanied by velocity-related data).

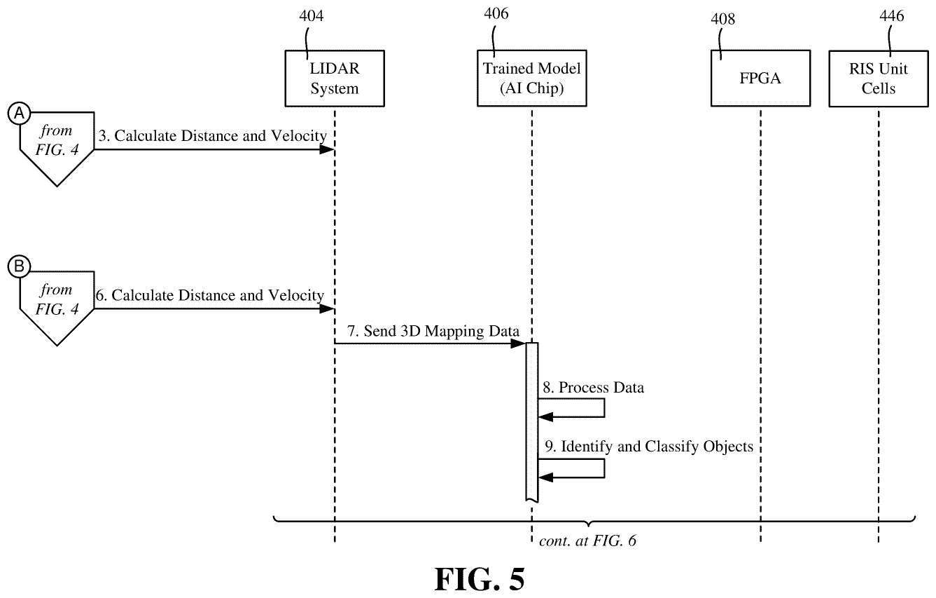

In this way, each reflected pulse is received by the LiDAR receiver 414, which calculates the distance and velocity of the target. The LiDAR system then sends 3D mapping data to the AI chip 406 (arrow (7) of FIG. 5), which processes the data to identify and classify objects (arrows (8) and 9)).

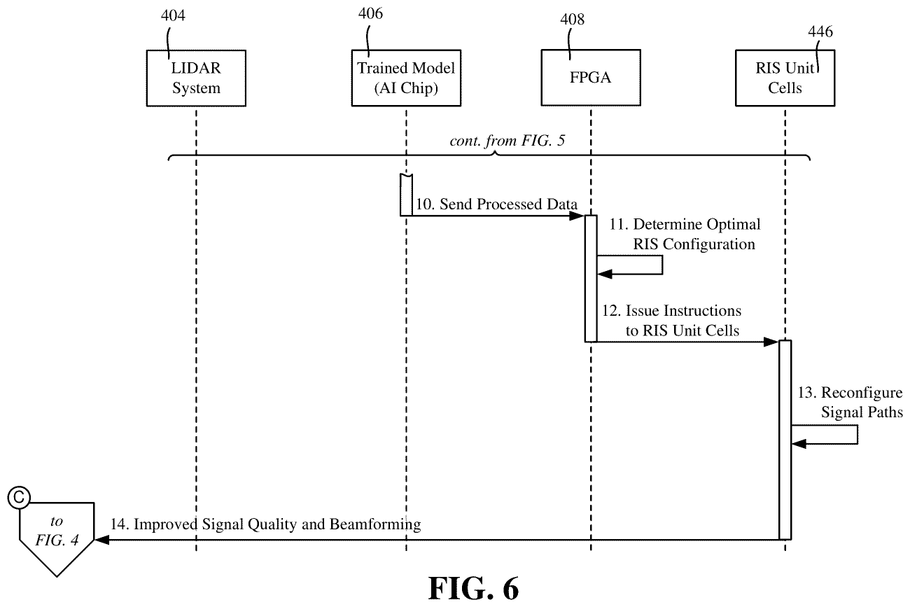

As represented by arrow (10) of FIG. 6, this processed data is forwarded to the FPGA 408, which determines the optimal RIS configuration (arrow (11)) and issues instructions to the RIS unit cells (arrow (12)). As represented by arrow (13), the RIS reconfigures its signal paths to improve signal quality and beamforming (symbolized by arrow (14)), ultimately enhancing communication links. The integration described herein thus facilitates dynamic environmental awareness, adaptive beamforming, and improved signal propagation in complex environments.

In one example implementation, the AI chip integrated on the RIS panel benefits from the combined use of a model set including (but not limited to) two AI models, including PointNet++ and deep reinforcement learning (DRL). The PointNet++ model (a neural network) is highly suitable for processing LiDAR data to create a precise 3D map of an environment, identifying objects and their locations. In this implementation, a DRL model uses this object/location information to dynamically adjust the RIS configuration, optimizing signal paths for improved communication performance.

In general, PointNet++ is an advanced version of PointNet designed for hierarchical feature learning in 3D point clouds. PointNet++ can effectively process raw LiDAR data, capturing local and global features to identify and classify objects in the environment. The local features include initial layers of the network focusing on small neighborhoods of points, capturing fine details and local geometry. Global features comprise higher layers combining these local features to understand broader structures and relationships within the point cloud, capturing more abstract and comprehensive information about the environment. Three such functions include using a hierarchical approach to capture fine-grained details at different scales, the capability of segmenting the environment into distinct objects and classes, also handling the noise and irregularities commonly found in LiDAR data. Note that this can be further improved by using an open-source MeshLab toolkit to map the environmental mapping in real-time, similar to the results shown in FIGS. 2 and 3. Note that near real-time may be sufficient in some scenarios, e.g., once per half-second sensing and processing may be suitable for mostly static scenarios like meeting rooms where people and moveable objects generally do not move particularly fast.

The DRL model is well-suited for handling the continuous and dynamic nature of the environment. A DRL model continuously learns and adapts by interacting with the environment. In this application, the DRL model optimizes the RIS configuration by maximizing a reward function, which can be designed to improve signal quality and coverage. Another benefit of a DRL model is that it can be scaled to handle large RIS arrays and complex environments.

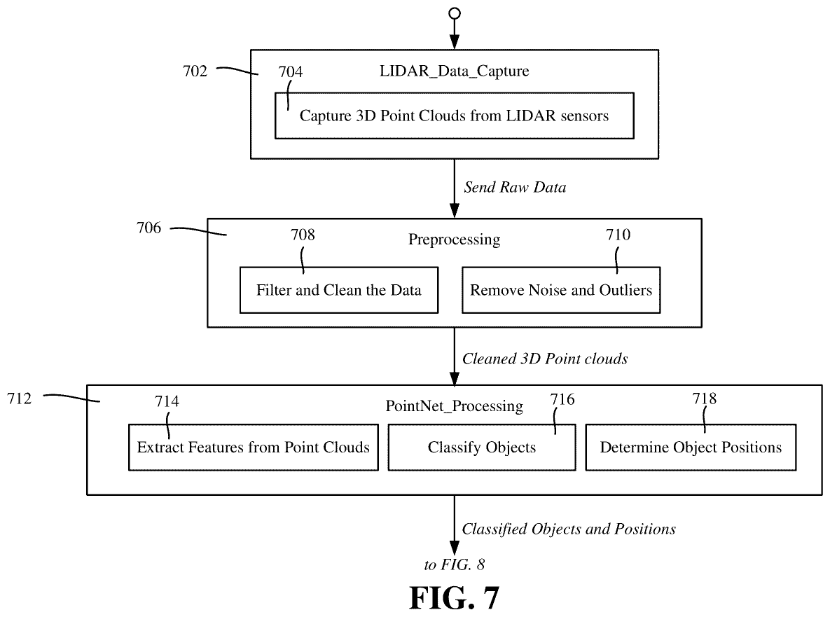

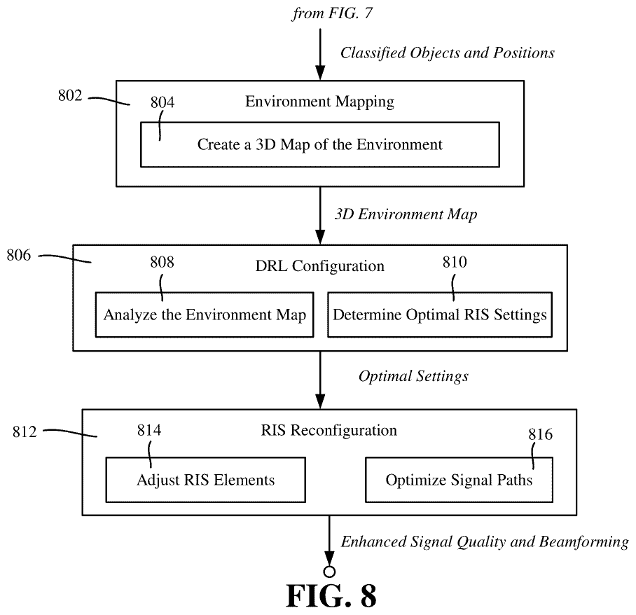

FIGS. 7 and 8 summarize the LiDAR system and RIS combination along with the AI model set, leveraging PointNet++ for detailed environmental understanding and DRL for intelligent, adaptive decision-making. This makes the overall system highly effective for the LiDAR integrated RIS hardware module, including for terahertz frequencies.

Block 702 of FIG. 7 represents the LiDAR data capture operations, including the capturing of 3D point clouds by the LiDAR sensors (operation 704). The raw data is sent for preprocessing (block 706), which can include filtering and cleaning of the data (operation 708) and removing noise and outliers (operation 710). Any of many available techniques can be used for such data preprocessing operations.

Following preprocessing, the cleaned 3D point clouds are sent for PointNet++ processing, represented by block 712. As described herein, this includes extracting features from the point clouds (operation 714), classifying objects (operation 716), and determining position data for the objects (operation 718).

The process continues at FIG. 8, block 802 representing environment mapping, which via operation 804 takes the classified objects and positions and creates a 3D map of the environment. The 3D environment map is input to the DRL configuration (block 806), which analyzes the environment map at operation 808, to determine optimal RIS settings (operation 810) for the environment.

RIS reconfiguration, represented via block 812, is based on these optimal settings. This includes adjusting the RIS elements (operation 814) to optimize the signal paths (operation 816), resulting in enhanced signal quality and beamforming. The operations of FIGS. 7 and 8 are repeated as appropriate for a given scenario, e.g., very rapidly for real-time environment-based reconfiguration.

One or more implementations can be embodied in a system, such as represented in the example embodiments and implementation described herein. The system can include a light detection and ranging (LiDAR) sensor device configured to obtain LiDAR mapping data representative of a mapping of objects in a three-dimensional environment, and a trained model set, coupled to the LiDAR sensor device. The trained model set can be configured to classify the objects into object identification data, and determine configuration data, based on the object identification data, for a reconfigurable intelligent surface that redirects communication signals in the three-dimensional environment. The system can include a controller configured to reconfigure the reconfigurable intelligent surface based on the configuration data.

The LiDAR sensor device can be physically coupled to the reconfigurable intelligent surface.

At least part of the trained model set can be incorporated into the controller.

The trained model set can include a neural network configured to classify the objects into object identification data.

The neural network can include a PointNet++ neural network.

The trained model set can include a deep reinforcement learning model configured to determine the configuration data.

The object identification data can indicate at least one of: a human or a communications device, and the trained model set can determine the configuration data for the reconfigurable intelligent surface to redirect an incoming communications signal into a redirected beam from the reconfigurable intelligent surface directed toward the at least one of the human or communications devices.

The object identification data can indicate a group of humans, and the trained model set can determine the configuration data for the reconfigurable intelligent surface to redirect an incoming communications signal into a redirected beam from the reconfigurable intelligent surface that covers a region in the three-dimensional environment that can include the group of humans.

The object identification data can indicate a group of communications devices, and wherein the trained model set can determine the configuration data for the reconfigurable intelligent surface to redirect an incoming communications signal into a redirected beam from the reconfigurable intelligent surface that covers a region in the three-dimensional environment that can include the group of communications devices.

The configuration data for the reconfigurable intelligent surface can adjust power of a redirected beam based on a communications signal impinging on the reconfigurable intelligent surface.

The object identification data can indicate absence of at least one human or communications device in the three-dimensional environment, and the trained model set can determine the configuration data for the reconfigurable intelligent surface to redirect an incoming communications signal to a location outside of the three-dimensional environment.

The object identification data can indicate absence of at least one human or communications device in the three-dimensional environment, and the trained model set can determine the configuration data to conserve power.

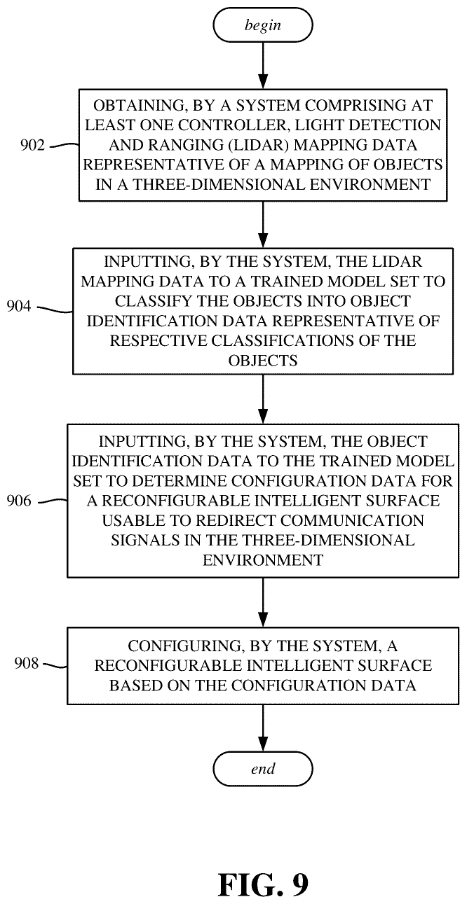

One or more example embodiments and/or implementations, such as corresponding to example operations of a method, can be represented in FIG. 9. Example operation 902 represents obtaining, by a system comprising at least one controller, light detection and ranging (LiDAR) mapping data representative of a mapping of objects in a three-dimensional environment. Example operation 904 represents inputting, by the system, the LiDAR mapping data to a trained model set to classify the objects into object identification data representative of respective classifications of the objects. Example operation 906 represents inputting, by the system, the object identification data to the trained model set to determine configuration data for a reconfigurable intelligent surface usable to redirect communication signals in the three-dimensional environment. example operation 908 represents configuring, by the system, a reconfigurable intelligent surface based on the configuration data.

Inputting the LiDAR mapping data to a trained model set to classify the objects into the object identification data can include inputting the LiDAR mapping data to a neural network.

Inputting the object identification data to the trained model set can include inputting the object identification data to a deep reinforcement learning model.

The object identification data can indicate at least one animate object or communications device, and configuring the reconfigurable intelligent surface based on the configuration data can redirect an incoming communications signal into a redirected beam focused on a region in the three-dimensional environment that encompasses the at least one animate object or communications device.

The object identification data can indicate absence of any animate object or communications device in the three-dimensional environment, at least one of the reconfigurable intelligent surface, or the at least one controller, can consumes power; further example operations can include taking action, by the system, to conserve consumption of the power by the at least one of the reconfigurable intelligent surface or the controller.

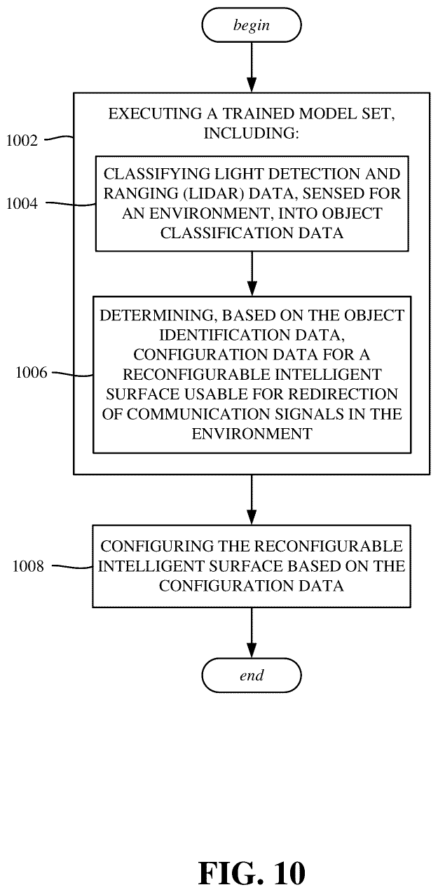

FIG. 10 summarizes various example operations, e.g., corresponding to a machine-readable medium, including executable instructions that, when executed by a processor of a target cluster, facilitate performance of operations. Example operation 1002 represents executing a trained model set, which includes example operations 1004 and 1006. Example operation 1004 represents classifying light detection and ranging (LiDAR) data, sensed for an environment, into object classification data. Example operation 1006 represents determining, based on the object identification data, configuration data for a reconfigurable intelligent surface usable for redirection of communication signals in the environment. Example operation 1008 represents configuring the reconfigurable intelligent surface based on the configuration data.

Executing the trained model set can include performing a first execution operation; the LiDAR data can be first LiDAR data sensed at a first time, the object classification data can be first object classification data, the configuration data can be first configuration data, and further operations can include performing a second execution operation, which can include classifying second LiDAR data, sensed for the environment sensed at a second time that can be later than the first time, into second object classification data, determining, based on the second object identification data, second configuration data for the reconfigurable intelligent surface, and reconfiguring the reconfigurable intelligent surface based on the second configuration data.

Classifying of the LiDAR data can include inputting the LiDAR data into a neural network model of the trained model set, and wherein the determining of the configuration data can include inputting the object identification data into a deep reinforcement learning model of the trained model set.

As can be seen, the technology described herein facilitates real-time environmental awareness and adaptive beamforming by integrating LiDAR with RIS. The LiDAR system provides precise 3D mapping and distance measurements, enabling dynamic adjustment of reflected signals to avoid obstacles, minimize interference, and optimize signal paths for robust communication in dynamic environments.

AI-based intelligent and efficient signal optimization can be performed, such as by utilizing an AI chip with PointNet++ and DRL. As described herein, the system processes LiDAR data to create precise 3D maps and dynamically adjust RIS configurations, ensuring intelligent, adaptive decision-making for improved signal quality and coverage. Scalable and flexible RIS configuration management can be based on a programmable logic chip (e.g., FPGA) controlled by AI, to manage RIS configurations, store coding sequences for dynamic tuning, and issue precise instructions to RIS unit cells; this facilitates efficient scaling to larger arrays, and adapting flexibly to complex environments.

Further, the technology described herein facilitates enhanced security and privacy in communication networks; leveraging LiDAR and AI can enhance environmental awareness for intrusion detection, ensuring secure communication paths by identifying and mitigating potential security threats, proactively addressing security and privacy challenges in RIS-based networks.

In sum, integrating LiDAR with RIS for joint sensing and communication, based on the rapid advancements in LiDAR technology that provide high-resolution 3D mapping capabilities, can be effectively harnessed for real-time environmental awareness. The integration of an AI model set, such as PointNet++ for detailed object classification and deep reinforcement learning for dynamic RIS configuration, leverages the strengths of both technologies to optimize signal paths and enhance communication performance. The use of an FPGA for scalable and flexible RIS management further adds to the system's adaptability and efficiency. Moreover, the increasing demand for secure and robust communication networks in applications like autonomous vehicles and smart cities is feasible with this integrated approach.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a light detection and ranging (LiDAR) sensor device configured to obtain LiDAR mapping data representative of a mapping of objects in a three-dimensional environment;
a trained model set, coupled to the LiDAR sensor device, the trained model set configured to:
classify the objects into object identification data, and
determine configuration data, based on the object identification data, for a reconfigurable intelligent surface that redirects communication signals in the three-dimensional environment; and
a controller configured to reconfigure the reconfigurable intelligent surface based on the configuration data.

2. The system of claim 1, wherein the LiDAR sensor device is physically coupled to the reconfigurable intelligent surface.

3. The system of claim 1, wherein at least part of the trained model set is incorporated into the controller.

4. The system of claim 1, wherein the trained model set comprises a neural network configured to classify the objects into object identification data.

5. The system of claim 1, wherein the neural network comprises a PointNet++ neural network.

6. The system of claim 1, wherein the trained model set comprises a deep reinforcement learning model configured to determine the configuration data.

7. The system of claim 1, wherein the object identification data indicates at least one of: a human or a communications device, and wherein the trained model set determines the configuration data for the reconfigurable intelligent surface to redirect an incoming communications signal into a redirected beam from the reconfigurable intelligent surface directed toward the at least one of the human or the communications device.

8. The system of claim 1, wherein the object identification data indicates a group of humans, and wherein the trained model set determines the configuration data for the reconfigurable intelligent surface to redirect an incoming communications signal into a redirected beam from the reconfigurable intelligent surface that covers a region in the three-dimensional environment that comprises the group of humans.

9. The system of claim 1, wherein the object identification data indicates a group of communications devices, and wherein the trained model set determines the configuration data for the reconfigurable intelligent surface to redirect an incoming communications signal into a redirected beam from the reconfigurable intelligent surface that covers a region in the three-dimensional environment that comprises the group of communications devices.

10. The system of claim 1, wherein the configuration data for the reconfigurable intelligent surface adjusts power of a redirected beam based on a communications signal impinging on the reconfigurable intelligent surface.

11. The system of claim 1, wherein the object identification data indicates absence of at least one human or communications device in the three-dimensional environment, and wherein the trained model set determines the configuration data for the reconfigurable intelligent surface to redirect an incoming communications signal to a location outside of the three-dimensional environment.

12. The system of claim 1, wherein the object identification data indicates absence of at least one human or communications device in the three-dimensional environment, and wherein the trained model set determines the configuration data to conserve power.

13. A method, comprising:
obtaining, by a system comprising at least one controller, light detection and ranging (LiDAR) mapping data representative of a mapping of objects in a three-dimensional environment;
inputting, by the system, the LiDAR mapping data to a trained model set to classify the objects into object identification data representative of respective classifications of the objects;
inputting, by the system, the object identification data to the trained model set to determine configuration data for a reconfigurable intelligent surface usable to redirect communication signals in the three-dimensional environment; and
configuring, by the system, a reconfigurable intelligent surface based on the configuration data.

14. The method of claim 13, wherein the inputting of the LiDAR mapping data to a trained model set to classify the objects into the object identification data comprises inputting the LiDAR mapping data to a neural network.

15. The method of claim 13, wherein the inputting of the object identification data to the trained model set comprises inputting the object identification data to a deep reinforcement learning model.

16. The method of claim 13, wherein the object identification data indicates at least one animate object or communications device, and wherein the configuring of the reconfigurable intelligent surface based on the configuration data redirects an incoming communications signal into a redirected beam focused on a region in the three-dimensional environment that encompasses the at least one animate object or communications device.

17. The method of claim 13, wherein the object identification data indicates absence of any animate object or communications device in the three-dimensional environment, wherein at least one of the reconfigurable intelligent surface, or the at least one controller, consumes power, and further comprising taking action, by the system, to conserve consumption of the power by the at least one of the reconfigurable intelligent surface or the controller.

18. A non-transitory machine-readable medium, comprising executable instructions that, when executed by at least one controller, facilitate performance of operations, the operations comprising:
executing a trained model set, comprising:
classifying light detection and ranging (LiDAR) data, sensed for an environment, into object classification data, and
determining, based on the object identification data, configuration data for a reconfigurable intelligent surface usable for redirection of communication signals in the environment; and
configuring the reconfigurable intelligent surface based on the configuration data.

19. The non-transitory machine-readable medium of claim 18, wherein the executing of the trained model set comprises performing a first execution operation, wherein the LiDAR data is first LiDAR data sensed at a first time, wherein the object classification data is first object classification data, wherein the configuration data is first configuration data, and wherein the operations further comprise:
performing a second execution operation, comprising:
classifying second LiDAR data, sensed for the environment sensed at a second time that is later than the first time, into second object classification data, and
determining, based on the second object identification data, second configuration data for the reconfigurable intelligent surface; and
reconfiguring the reconfigurable intelligent surface based on the second configuration data.

20. The non-transitory machine-readable medium of claim 18, wherein the classifying of the LiDAR data comprises inputting the LiDAR data into a neural network model of the trained model set, and wherein the determining of the configuration data comprises inputting the object identification data into a deep reinforcement learning model of the trained model set.
